(19) United States
(12) Patent Application Publication
(10) Pub. No.: US 2022/0391839 A1
(43) Pub. Date: Dec. 8, 2022

(54) SYSTEM AND METHOD TO MONITOR AN INVENTORY AND TRANSPORTATION OF THE MATERIALS BETWEEN THE PARTIES

(71) Applicants: Mark Childerson, TORONTO (CA); Vlad Mandrychenko, TORONTO (CA); Rob Bowd, TORONTO (CA); Gerrome Tan, TORONTO ON (CA)

(72) Inventors: Mark Childerson, TORONTO (CA); Vlad Mandrychenko, TORONTO (CA); Rob Bowd, TORONTO (CA); Gerrome Tan, TORONTO ON (CA)

(21) Appl. No.: 17/890,396

(22) Filed: Aug. 18, 2022

Related U.S. Application Data
(60) Provisional application No. 63/294,169, filed on Dec. 28, 2021.

(51) Int. Cl. G06Q 10/08

(52) U.S. Cl. CPC G06Q 10/0835; G06Q 10/087

(57) ABSTRACT

The present invention relates to monitoring of inventory and transportation of materials. The method may include; receiving, from a first computing device, a first search query which is input by a first warehouser, to identify the materials for shipment; receiving, from the first computing device, a transfer request to initiate the shipment for the each of the materials (EOTM), the transfer request comprising a destination location and a carrier data; receiving, from a second computing device, for the EOTM, a verification input to verify a departure status from a first contractor; generating a shipment document, for the EOTM, after verification of the departure status, wherein the shipment document is associated with a QR code; receiving, for the EOTM, a destination arrival status from a carrier, upon a drop-off of the materials; creating, a transfer log which enables monitoring of the material transportation.

### FIELD OF THE INVENTION

The present invention relates generally to supply chain management, more particularly, to monitor an inventory and transportation of the materials between the parties.

### BACKGROUND

The background description includes information that may be useful in understanding the present invention. It is not an admission that any of the information provided herein is prior art or relevant to the presently claimed invention, or that any publication specifically or implicitly referenced is prior art.

A supply and distribution chain system encompasses may entities, actions, information exchange and delivery of goods or services from a supplier to a client. The transformation of materials or data into a finished product or service that can be delivered or otherwise offered to an end user is one example of an activity. The chain can be found within a single entity or across multiple business entities within a specific product or service industry.

Modern trade channels, such as international supply and distribution chains enables transportation of valuable items from sources to destinations, around the world. A typical supply and distribution chain starts at a production plant, where goods are created and placed into shipping containers before being transported to a sea port by vehicle or train. The shipping containers are loaded onto ships and carried across different bodies of water at the port. The ships are emptied after they arrive at their destination, and the shipping containers are transported by truck or train to one or more rail yards, and ultimately to distribution facilities. The goods are then divided into smaller quantities, sometimes onto individual pallets or boxes, and loaded onto trucks for delivery to their final destinations, which are frequently retail outlets, client sites, or other production plants.

For identifying and locating commodities in such chains, expensive and labour-intensive tracking systems are already available. These systems, on the other hand, do not provide end-to-end transit operation optimization and necessitate a great deal of human involvement and maintenance, significantly limiting their usefulness. Various traditional asset tracking systems can only cover parts of a chain, and many functions are often handled as wholly separate occurrences with no connection (and with human operators). Fulfilment, for example, might be handled separately from supplier payments or even order administration. In addition, several dates are manually recorded, tracked, and altered based on the product's predicted delivery status. Because the sequence of information, products, and currency might change according on the needs of the specific customers, suppliers, and logistics providers who use the network, this is an extremely costly and time-consuming operation. Because these legacy systems and methods lack the resources or time to properly manage their supply and distribution chain, suppliers and customers frequently find themselves paying higher prices, being short of products during times of high demand, forecasting needs incorrectly, and creating slow moving inventories. An autonomous supply and distribution chain management system is required that can offer complete information about each asset and how it interacts with other assets in the supply chain, as well as optimise transit operations based on asset compatibilities and other restrictions.

However, the technological solutions for monitoring an inventory and transportation of the materials between the parties suffer from various limitations such as inaccurate tracking between parties, expensiveness, time consuming, etc. Thus, there remains a need for further contributions in this area of technology. More specifically, a need exists in the area of technology to monitor an inventory and transportation of the materials between the parties.

### SUMMARY

The present invention relates generally to supply chain management, more particularly, to monitor an inventory and transportation of the materials between the parties.

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

The following paragraphs provide additional support for the claims of the subject application.

In an aspect the present disclosure provides a system to monitor an inventory and transportation of the materials between the parties, the system comprises: a server arrangement comprising: a non-transitory storage device that is arranged to store a set of executable routines; and a microprocessor which is coupled to the non-transitory storage device and operable to execute the set of routines to: receive, from a first computing device, a first search query which is input by a first warehouser, to identify the materials for which shipment is ready; receive, from the first computing device, a transfer request to initiate the shipment for the each of the materials (EOTM), the transfer request comprising: a destination location; and a carrier data; receive, from a second computing device, for the EOTM, a verification input to verify a departure status from a first contractor; generate a shipment document, for the EOTM, after verification of the departure status, wherein the shipment document is associated with a quick response (QR) code; receive, for the EOTM, a destination arrival status from a carrier, upon a drop-off of the materials at the destination location; and create, for the EOTM, a transfer log that is associated with the QR code, wherein the transfer log enables monitoring the material transportation between the parties and the inventory.

In another aspect the present disclosure provides a method for monitoring an inventory and transportation of the materials between the parties, the method comprises: arranging a server arrangement for: receiving, from a first computing device, a first search query which is input by a first warehouser, to identify the materials for which shipment is ready; receiving, from the first computing device, a transfer request to initiate the shipment for the each of the materials (EOTM), the transfer request comprising: a destination location; and a carrier data; receiving, from a second computing device, for the EOTM, a verification input to verify a departure status from a first contractor; generating a shipment document, for the EOTM, after verification of the departure status, wherein the shipment document is associated with a QR code; receiving, for the EOTM, a destination arrival status from a carrier, upon a drop-off of the materials at the destination location; and creating, for the EOTM, a transfer log that is associated with the QR code, wherein the transfer log enables monitoring the material transportation between the parties and the inventory.

In an embodiment, the server arrangement determines an expected date of delivery of EOTM, based on the delivery location and departure status, corresponding to the EOTM.

In an embodiment, the server arrangement transmits the determined expected date of delivery on a computing terminal associated with a recipient of the EOTM.

In an embodiment, the server arrangement transmits the shipment document on the computing terminal associated with the recipient of the EOTM, to track a current transportation status of the EOTM.

In an embodiment, the server arrangement transmits an alert message on the computing terminal associated with the recipient of the EOTM, based on the current transportation status of the EOTM.

In an embodiment, the computing terminal scans the QR code associated with the shipping document, upon the drop-off of the EOTM, to acknowledge a receipt of the material by the recipient.

In an embodiment, the server arrangement transmits a feedback link on the computing terminal associated with the recipient, upon the drop-off of the EOTM.

In an embodiment, the server arrangement archives the created transfer logs corresponding to EOTM in the non-transitory storage device, for future reference, upon receiving the destination arrival status from the carrier.

### BRIEF DESCRIPTION OF THE DRAWINGS

The features and advantages of the present disclosure would be more clearly understood from the following description taken in conjunction with the accompanying drawings in which:

FIG. 1 illustrates a representation to monitor an inventory and transportation of the materials between the parties and components/elements thereof, in accordance with embodiment of present disclosure

FIG. 2 illustrates an exemplary representation record of EOTM, in accordance with embodiments of the present disclosure.

FIG. 3 illustrates exemplary functional unit to monitor an inventory and transportation of the materials between the parties, in accordance with embodiments of the present disclosure.

FIG. 4 illustrate exemplarily steps to monitor an inventory and transportation of the materials between the parties, in accordance with embodiments of the present disclosure.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to claim those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The present invention relates generally to supply chain management, more particularly, to monitor an inventory and transportation of the materials between the parties.

Referring now to the invention in more detail, in FIG. 1 there is shown a representation 100 to monitor an inventory and transportation of the materials between the parties and components/elements thereof, in accordance with embodiments of present disclosure. Referring now to the invention in more detail. As illustrated in FIG. 1, there is shown a first computing device 102, a server arrangement 104, a second computing device 106, a carrier 108, and other known components of a supply chain management application/platform. Data communication means can enable communication among different components, or external computing environment, and an electrical energy source to provide electrical energy to the one or more components of system architecture 100. It can be appreciated that the aforementioned components of system architecture 100 are communicably coupled with each other.

In an embodiment, as a STEP 1, the first computing device 102 can be arranged to receive a first search query, which can be provided by a first warehouser, in order to identify the materials for which shipment is ready and the materials are yet not shipped. The first warehouser can be a person employee or warehouse administrator, who can access various commodities, which can be stored at various compartment. Manufacturers, importers, exporters, wholesalers, transportation companies, customs, and others may utilize warehouses for storage of commodities. The warehouser may be responsible for tracing order details to determine: (a) available stock of material, (b) packaging status, (c) material is ready to ship, (d) material is shipped, (e) material transient status, (f) delivery status, and (g) return shipment status. The search query can be in form of textual, audio, image or any other suitable format. The first search query may comprise order identifier, product code, invoice number, shipment tracking ID etc.

According to an embodiment, as a STEP 2, the search query is transmitted, over communication network, from the first computing device 102 to server arrangement 104. In STEP 3, based on the received search query, server arrangement 104 utilizes the non-transitory storage device 104A to fetch/identify a list of orders, which can be in a pending stage or yet to be shipped. Further, for each pending order, the server arrangement 108 can identify the materials for which shipment is ready. In next STEP 4, server arrangement 104 can transmit the details of identified pending order and shipment ready materials to the first computing device 102. A graphical user interface associated with the first computing device 102 can enable display of the received details (from server arrangement 104) of identified pending order and shipment ready materials.

In an aspect, in STEP 5, the warehouser can access the first computing device 102 to submit a transfer search request to initiate the shipment for the each of the materials (EOTM). To determine aforementioned details the warehouser may transmit first search query to server arrangement 104, which may comprise all data related to current orders and order related data (e.g., shipping address, payment data, item specification etc.). The search request may comprise a destination location (e.g., zip code, street address, GPS coordinates etc.), where EOTM has to be delivered, a carrier data, a pickup location (e.g., seller location or warehouse location) from where the EOTM needs to be picked and a priority order to prioritize the handling of the ETOM. The delivery location can be within a city, within a state, within a country or outside a country. The initiated transfer request may also comprise a carrier data, which can be an information (logistic partner name, transient mode, etc.) regarding the carrier 108, which may carry the EOTM at the destination location, where a recipient could receive the EOTM. The first computing device 102 may provide the received transfer request to the server arrangement 104, in a run-time manner or polling manner through known communication means. The first computing device 102 can be selected from a laptop, a desktop computer, a smart phone, etc.

In an embodiment, as STEP 6, the second computing device 106 can be arranged to receive a verification input from a first contractor, wherein the verification input can be used to verify a departure status of the EOTM. The verification input from the first contractor can be a second stage authorization regarding shipment and departure of the EOTM. If EOTM has departed, the first contractor may provide the verification input as “EOTM departed”, else the first contractor may provide verification input as “EOTM not departed”. The second computing device 106 may provide the verification input to server arrangement 104 in a run-time manner or polling manner through known communication means. The second computing device 106 can be selected from a laptop, a desktop computer, a smart phone, etc. Further, the carrier 108 can be arranged to pickup the EOTM from the warehouse and carry the picked EOTM for delivery at the destination location, where the recipient could receive the EOTM. The carrier 108 may be equipped with a third computing device which could receive a destination arrival status from a carrier personal, wherein the received destination arrival status may refer to the arrival of EOTM at the intended destination. The server arrangement 104 could acquire the received destination arrival status from the third computing device in a run-time manner or polling manner through known communication means. A corporation or a person with legal authority to carry EOTM by land, sea, or air is known as carrier 108. Typically, the carrier 108 may collaborate with a warehouser to transport EOTM from one location to another. In an embodiment, the server arrangement 104 can be arranged to receive the transfer request from computing device 102 and the verification input from the second computing device 106.

In an embodiment, as STEP 7, server arrangement 104 may generate a shipping document based on the transfer request and the verification input, wherein the shipping document can be utilized by recipient of the EOTM for tracking a current transportation status of the EOTM. The shipping document can be associated with a unique code, for an instance, QR code. The server arrangement 104 may comprise a non-transitory storage device 104-A and a microprocessor.

In an embodiment, the non-transitory storage device 104-A can be arranged to store a set of routines which can be executed by the microprocessor to enable the tracking of current transportation status of the materials between parties. The non-transitory storage device 104A can be a flash drive, RAM or other known types of electronic data storage devices.

In an embodiment, the microprocessor can be arranged to enable monitoring of the inventory and transportation of the materials between parties. The microprocessor may receive the first search query from the first computing device 102, wherein the first search query can be input by the first warehouser. The first search query can be utilized to identify the materials for which shipment is ready and the materials are yet not shipped. The microprocessor may receive a transfer request (for the EOTM) from the first computing device 102, in order to initiate the shipment (from warehouse), which can be delivered to the recipient. The transfer request may comprise destination location (which relates to location of the recipient) and the carrier data (which relates to information regarding carrier 108). The microprocessor may receive the verification input (for the EOTM) from the second computing device 106, wherein the verification input can be utilized to verify the departure status from the first contractor, thereby providing a multi-level verification regarding the shipping and departure of the EOTM. The microprocessor may generate a shipment document corresponding to the EOTM after verification of the departure status, wherein the shipment document can be associated with a quick response (QR) code. The shipping document may comprise each and every detail referring to the arrival of EOTM at intermediate locations (refers to sub-stations between warehouse and destination location of recipient). The shipping document can be accessed by the recipient or any other person (warehouser, etc.) scanning the QR code. The microprocessor may receive, a destination arrival status of the EOTM from the carrier 108, upon a drop-off of the materials at the destination location, where the recipient might be available to receive the material being dropped. The microprocessor may create a transfer log for the EOTM, wherein the transfer log can be associated with the QR code. The transfer log may enable monitoring of the material transportation between the parties and the inventory so that the recipient or any other party may get current transportation status of the EOTM.

In an embodiment, at STEP 8, upon drop-off of EOTM at destination location, server arrangement 104 may receive destination arrival status. In other words, server arrangement 104 may determine an expected date of delivery of EOTM, based on the delivery location and departure status, corresponding to the EOTM as an expected date of delivery may vary for one delivery location (which can be at a remote location) as compared to another which can be at a nearer location. The expected date of delivery can be estimated by evaluating the time taken to reach each sub-stations between the warehouse and delivery location. The expected date of delivery may provide a tentative idea to the recipient regarding the arrival of EOTM, so that he/she might make necessary arrangements for receiving the EOTM.

In another embodiment, the EOTM can be associated with a location monitoring unit (e.g., GPS sensing unit) that can be capable of tracking a location of the EOTM. The tracked location of EOTM would prevent fraudulent data entry about location by various parties. Further, tracked location would also provide information about transient location and tentative date of delivery.

In an aspect, the server arrangement 104 may classify the EOTM based on similarity. Classification can be based on at least one parameter selected from delivery location, category of goods, logistic carrier partner, and like that.

In an embodiment, the server arrangement 104 may transmit the determined expected date of delivery on a computing terminal associated with the recipient of the EOTM so that he/she might be available at the destination location on the transmitted expected date of delivery. The recipient of the EOTM might make necessary arrangements so that someone else might be available at the destination location for retrieval of the EOTM at the determined expected date of delivery. The computing terminal can be selected from a laptop, a desktop, a smartwatch, a mobile phone, a tablet computer, etc.

In an embodiment, the server arrangement 104 may transmit the shipment document on the computing terminal associated with the recipient of the EOTM, so that the recipient may track a current transportation status of the EOTM, wherein the current transportation status may depict a time when EOTM has arrived or departed any sub-station. The shipment document can also be transmitted to each of the sub-stations, which may append the arrival time/arrival date and departure time/departure date, within the shipping document.

In an embodiment, the server arrangement 104 may transmit an alert message on the computing terminal associated with the recipient of the EOTM, based on the current transportation status of the EOTM so that the recipient may get aware of arrival time and departure time of EOTM at each of the sub-stations.

In an embodiment, the computing terminal may scan the QR code associated with the shipping document, upon the drop-off of the EOTM, thereby providing an acknowledgement regarding the acquisition of the material by the recipient, who may update a delivery status from his/her side (after scanning), thereby cross-verifying that EOTM has been delivered at the delivery location (intended).

In an embodiment, the server arrangement 104 may generate and transmit a feedback link on the computing terminal associated with the recipient, upon the drop-off of the EOTM, wherein the feedback link once clicked may open a feedback form that can be filled by the recipient after receiving the EOTM. The recipient may provide the feedback regarding behaviour of delivery person, either delivery of EOTM was touchless, etc.

In an embodiment, at STEP 9, the server arrangement 104 may archive the created transfer logs corresponding to EOTM in the non-transitory storage device 104A, for future reference, upon receiving the destination arrival status from the carrier 108, wherein the transfer logs can be stored for a pre-set duration (for example 60 days). The transfer logs aids in real time monitoring status of EOTM. Such logs can be fetched any time within the pre-set duration by the recipient or any other party as per requirement.

In an aspect, the known transportation monitoring mechanism lacks continuity in tracking the current transportation status of the material due to irregular updation at the sub-stations (intermediate locations). The known inventory monitoring mechanism have also depicted errors while selecting and dispatching the material, thereby resulting in delivery of wrong material to the recipient. The present disclosure provides a multi-prong approach to provide the multi-level verification of the material before dispatching, thereby minimizing a probability of delivering wrong product to the recipient. The present disclosure provides an efficient mechanism of tracking the current transportation of the material by providing the QR code (increasing the ease of opening sub-sections of an application for tracking the current transportation status of the material). The present disclosure transmits alert message on the first computing device 102 regarding the current transportation status, thereby making the recipient aware about current transportation status of the material.

In an embodiment, the present disclosure can be implemented as a web-based model that can be flexible enough to represent a lifecycle of the material/item that can be shipped in the complex supply chain. The web-based system incorporates a common data source to enable coordination of multiple internal/external data inputs through a common platform that is readily accessible by plethora of users. Additionally, the web-based model amplifies visibility of all relevant materials at all promising locations for appropriate stakeholders, including hand-offs of materials between stakeholders. Further, an automation of work processes such as triggering of automated alerts/notifications (e.g., SMS, electronic messages, instant messenger message, audio signal, multimedia data, and the like) based on defined business rules and auto-expediting workflows can be performed. Moreover, tracking of milestone (example—historical information) updates and timing of such updates over time uplifts overall quality of material handling data. Real time reports can be provided to simplify information gathering and provide material inventory status. Further, the system delivers pre-defined & flexible reports along with data exports for higher-end analytics. Moreover, a third-party performance management can be even provided by the web-based system.

In an embodiment, the present disclosure enables unlimited number of use cases such as simultaneously tracking of shipments by multiple users. The disclosure enables efficient management of entire life cycle of supply chain management such as tracking part generation, manufacturing, shipment, inventory, installation and disposal.

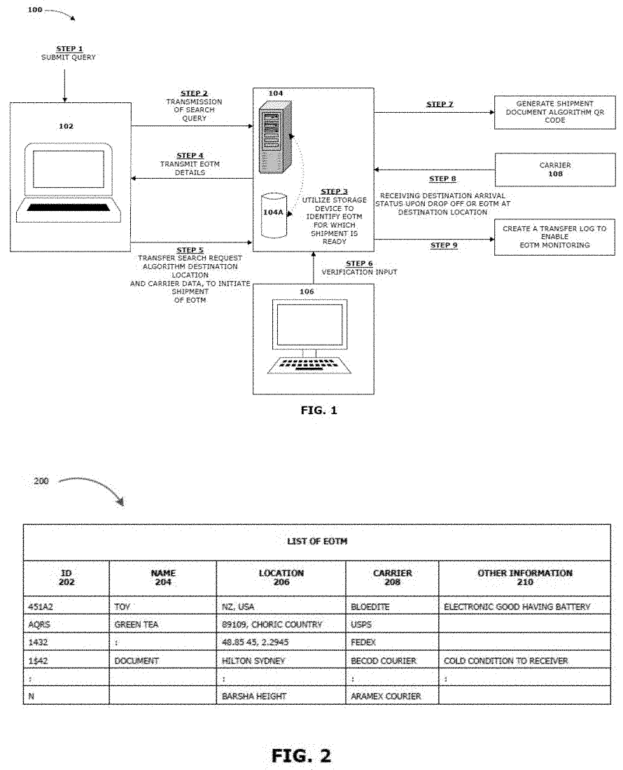

FIG. 2 illustrates an exemplary representation record 200 of EOTM. The record may include details pertaining to multiple EOTM, unique identifier 202, name 204, delivery/destination location 206, carrier 208 and any other information 210 related to EOTM. For an instance, ID 451A2 corresponds to iPhone 11 that needs to be delivered at New Jersey (NJ) USA via Bluedart and instruction is “Electronic good having battery”. In another example, AQR5 corresponds to vacuum cleaner that needs to be delivered at 89109 clark county via USPS but no instruction. Illustrated names, fields, instructions are completely exemplary in nature and any other suitable detail can form part of record 200.

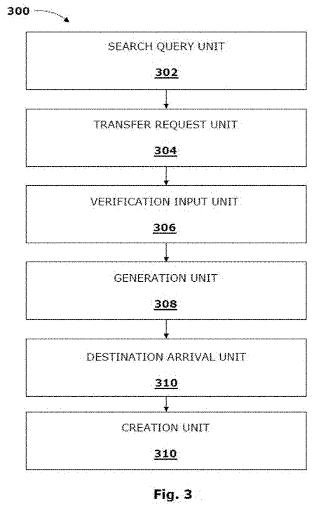

FIG. 3 illustrates exemplary functional unit 300 to monitor an inventory and transportation of the materials between the parties, in accordance with embodiments of the present disclosure. As illustrated, the functional unit 300 can comprise a search query unit 302, a transfer request unit 304, a verification input unit 306, a generation unit 308, a destination arrival unit 310 and a creation unit 312. The functional unit 300 can be executed by the microprocessor.

In an embodiment, the search query unit 302 can be configured to receive the first search query from the first computing device 102, wherein the first search query can be provided by the first warehouser, in order to identify the materials for which shipment is ready and the materials are yet not shipped to the delivery location of the recipient, upon receiving an order input from the recipient.

In an embodiment, the transfer request unit 304 can be configured to receive a transfer request from the first computing device 102, in order to initiate the shipment for the each of the materials (EOTM). The transfer request may comprise the delivery location of the recipient, where EOTM has to be delivered. The transfer request may comprise a carrier data, which may relate to the carrier 108 that might carry the EOTM at the destination location.

In an embodiment, the verification input unit 306 can be configured to receive a verification input (for the EOTM) from the second computing device 106, in order to verify a departure status from the first contractor for providing a double-step authentication (that EOTM has been shipped and departed from warehouse to delivery location of recipient).

In an embodiment, the generation unit 308 can be configured to generate a shipment document for the EOTM, after verification of the departure status, wherein the shipment document can be associated with a QR code which can be scanned for gathering the current transportation status of the EOTM. The shipment document may be updated after the carrier 108 reaches each of the sub-stations (multiple intermediate locations between warehouse and destination location).

In an embodiment, the destination arrival unit 310 can be configured to receive a destination arrival status (for the EOTM) from the carrier 108, upon a drop-off of the materials at the destination location, where recipient could receive the EOTM. Delivery person (who may be a representative of carrier 108) could handover the EOTM to the recipient.

In an embodiment, the creation unit 312 can be configured to create a transfer log (for the EOTM) that can be associated with the QR code, wherein the transfer log may enable monitoring of the material transportation between the parties and the inventory in order to keep a check on the current transportation status of EOTM. The transfer log can be utilized by each party for tracking the current transportation status of the EOTM.

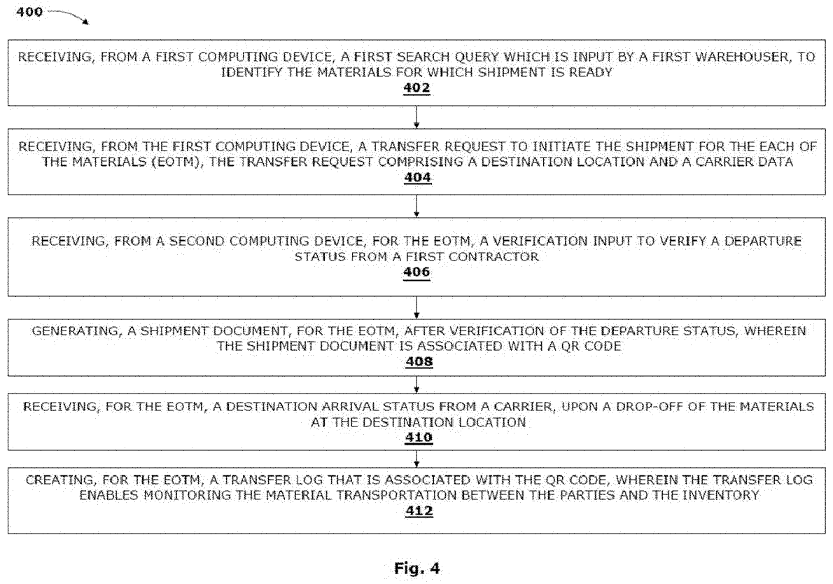

FIG. 4 illustrate exemplarily steps to monitor an inventory and transportation of the materials between the parties, in accordance with embodiments of the present disclosure. As illustrated in flow diagram 400, the method may include steps of: at step (402) receiving, from a first computing device, a first search query which is input by a first warehouser, to identify the materials for which shipment is ready; at step (404) receiving, from the first computing device, a transfer request to initiate the shipment for the each of the materials (EOTM), the transfer request comprising a destination location and a carrier data; at step (406) receiving, from a second computing device, for the EOTM, a verification input to verify a departure status from a first contractor; at step (408) generating a shipment document, for the EOTM, after verification of the departure status, wherein the shipment document is associated with a QR code; at step (410) receiving, for the EOTM, a destination arrival status from a carrier, upon a drop-off of the materials at the destination location; at step (412) creating, for the EOTM, a transfer log that is associated with the QR code, wherein the transfer log enables monitoring the material transportation between the parties and the inventory.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

Throughout the present disclosure, the term ‘processing means’ or ‘microprocessor’ or ‘processor’ or ‘processors’ includes, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

I/We claim:

1. A system to monitor an inventory and transportation of the materials between the parties, the system comprises:
a server arrangement comprising:
a non-transitory storage device that is arranged to store a set of executable routines; and
a microprocessor which is coupled to the non-transitory storage device and operable to execute the set of routines to:
receive, from a first computing device, a first search query which is input by a first warehouser, to identify the materials for which shipment is ready;
receive, from the first computing device, a transfer request to initiate the shipment for the each of the materials (EOTM), the transfer request comprising:
a destination location; and
a carrier data;
receive, from a second computing device, for the EOTM, a verification input to verify a departure status from a first contractor;
generate a shipment document, for the EOTM, after verification of the departure status, wherein the shipment document is associated with a quick response (QR) code;
receive, for the EOTM, a destination arrival status from a carrier, upon a drop-off of the materials at the destination location; and
create, for the EOTM, a transfer log that is associated with the QR code, wherein the transfer log enables monitoring the material transportation between the parties and the inventory.

2. The system of claim 1, wherein the EOTM comprising a location monitoring unit that is capable of tracking a location of the EOTM.

3. The system of claim 1, wherein the server arrangement classifies the EOTM based on similarity.

4. The system of claim 1, wherein the server arrangement determines an expected date of delivery of the EOTM.

5. The system of claim 1, wherein the server arrangement transmits the shipment document on the computing terminal associated with the recipient of the EOTM, to track a current transportation status of the EOTM.

6. The system of claim 6, wherein the server arrangement transmits a feedback link on the computing terminal associated with the recipient, upon the drop-off of the EOTM.

7. The system of claim 1, wherein the server arrangement archives the created transfer logs corresponding to EOTM in the non-transitory storage device, for future reference, upon receiving the destination arrival status from the carrier.

8. The system of claim 7, wherein the transfer request comprising information related to a priority order to prioritize handling of the ETOM.

9. A method for monitoring an inventory and transportation of the materials between the parties, the method comprises:
arranging a server arrangement for:
receiving, from a first computing device, a first search query which is input by a first warehouser, to identify the materials for which shipment is ready;
receiving, from the first computing device, a transfer request to initiate the shipment for the each of the materials (EOTM), the transfer request comprising:
a destination location; and
a carrier data;
receiving, from a second computing device, for the EOTM, a verification input to verify a departure status from a first contractor;
generating a shipment document, for the EOTM, after verification of the departure status, wherein the shipment document is associated with a QR code;
receiving, for the EOTM, a destination arrival status from a carrier, upon a drop-off of the materials at the destination location; and
creating, for the EOTM, a transfer log that is associated with the QR code, wherein the transfer log enables monitoring the material transportation between the parties and the inventory.

10. The method in claim 9, wherein the server arrangement determines an expected date of delivery of EOTM, based on the delivery location and departure status, corresponding to the EOTM.

11. The method in claim 9, wherein the EOTM comprising a location monitoring unit that is capable of tracking a location of the EOTM.

12. The method in claim 9, wherein the server arrangement classifies the EOTM based on similarity.

13. The method in claim 9, wherein the server arrangement determines an expected date of delivery of the EOTM.

14. The method in claim 9, wherein the server arrangement transmits the shipment document on the computing terminal associated with the recipient of the EOTM, to track a current transportation status of the EOTM.

15. The system of claim 14, wherein the server arrangement transmits a feedback link on the computing terminal associated with the recipient, upon the drop-off of the EOTM.

16. The method in claim 9, wherein the server arrangement archives the created transfer logs corresponding to EOTM in the non-transitory storage device, for future reference, upon receiving the destination arrival status from the carrier.

17. The method in claim 16, wherein the transfer request comprising information related to a priority order to prioritize handling of the ETOM.

18. A non-transitory computer-readable storage medium, comprising executable instructions that, when executed by a processing system including a processor, facilitate monitoring an inventory and transportation of the materials between the parties, comprising:
receiving, from a first computing device, a first search query which is input by a first warehouser,
to identify the materials for which shipment is ready;
receiving, from the first computing device, a transfer request to initiate the shipment for the each of the materials (EOTM), the transfer request comprising:
a destination location; and
a carrier data;
receiving, from a second computing device, for the EOTM, a verification input to verify a departure status from a first contractor;
generating a shipment document, for the EOTM, after verification of the departure status, wherein the shipment document is associated with a QR code;
receiving, for the EOTM, a destination arrival status from a carrier, upon a drop-off of the materials at the destination location; and
creating, for the EOTM, a transfer log that is associated with the QR code, wherein the transfer log enables monitoring the material transportation between the parties and the inventory.
